(19) United States
(12) Patent Application Publication
(10) Pub. No.: US 2017/0205756 A1
(43) Pub. Date: Jul. 20, 2017

(54) CLEANING ELECTROPHOTOGRAPHIC PRINTING DRUMS

(71) Applicants: Krzysztof NAUKA, Palo Alto, CA (US); HEWLETT-PACKARD INDIGO B.V., Amstelveen (NL)

(72) Inventors: Krzysztof Nauka, Palo Alto, CA (US); Reut Diamant, Nes Ziona (IL); Sasi Moalem, Nes Ziona (IL)

(21) Appl. No.: 15/326,090

(22) PCT Filed: Jul. 30, 2014
(86) PCT No.: PCT/US2014/048893

§ 371 Date: Jan. 13, 2017

(51) Int. Cl. G03G 21/00

(52) U.S. Cl. CPC G03G 21/0005

(57) ABSTRACT

There is provided a method of cleaning an amorphous silicon electrophotographic printing drum. the method comprises contacting the amorphous silicon of the drum with a base and an oxidising agent; and then rinsing the amorphous silicon with a liquid.

### BACKGROUND

Electrostatic printing processes may involve creating an image on a photoconductive surface, applying an ink having charged particles to the photoconductive surface, such that they selectively bind to the image, and then transferring the charged particles in the form of the image to a print substrate.

The photoconductive surface can be on a cylinder and is often termed a photo imaging plate (PIP). The photoconductive surface can be selectively charged with a latent electrostatic image having image and background areas with different potentials. For example, an electrostatic ink composition comprising charged toner particles in a carrier liquid can be brought into contact with the selectively charged photoconductive surface. The charged toner particles adhere to the image areas of the latent image while the background areas remain clean. The image is then transferred to a print substrate (e.g. paper) directly or, more commonly, by being first transferred to an intermediate transfer member, which can be a soft swelling blanket, and then to the print substrate. Variations of this method utilize different ways for forming the electrostatic latent image on a photoreceptor or on a dielectric material.

### BRIEF DESCRIPTION OF THE FIGURES

FIG. 1 shows schematically an example of a method of cleaning as described herein.

FIG. 2 shows a print media having been printed using an electrophotographic printing drum, a portion of which has been cleaned using an example of a method as described herein.

### DETAILED DESCRIPTION

Before the present method and related aspects are disclosed and described, it is to be understood that they are not limited to the particular process steps and materials disclosed herein because such process steps and materials may vary somewhat. It is also to be understood that the terminology used herein is used for the purpose of describing particular examples only. The terms are not intended to be limiting because the scope of the present disclosure is intended to be limited only by the appended claims and equivalents thereof.

It is noted that, as used in this specification and the appended claims, the singular forms “a,” “an,” and “the” include plural referents unless the context clearly dictates otherwise.

If a standard test is mentioned herein, unless otherwise stated, the version of the test to be referred to is the most recent at the time of filing this patent application.

As used herein, “electrostatic printing” or “electrophotographic printing” generally refers to the process that provides an image that is transferred from a photo imaging substrate either directly, or indirectly via an intermediate transfer member, to a print substrate. As such, the image is not substantially absorbed into the photo imaging substrate on which it is applied. Additionally, “electrophotographic printers” or “electrostatic printers” generally refer to those printers capable of performing electrophotographic printing or electrostatic printing, as described above. “Liquid electrophotographic printing” is a specific type of electrophotographic printing where a liquid ink is employed in the electrophotographic process rather than a powder toner. An electrostatic printing process may involve subjecting the electrostatic ink composition to an electric field, e.g. an electric field having a field gradient of 1000 V/cm or more, or in some examples 1500 V/cm or more.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 wt % to about 5 wt %” should be interpreted to include not only the explicitly recited values of about 1 wt % to about 5 wt %, but also include individual values and subranges within the indicated range. Thus, included in this numerical range are individual values such as 2, 3.5, and 4 and sub-ranges such as from 1-3, from 2-4, and from 3-5, etc. This same principle applies to ranges reciting only one numerical value. Furthermore, such an interpretation should apply regardless of the breadth of the range or the characteristics being described.

Unless otherwise stated, any feature described herein can be combined with any aspect or any other feature described herein.

Examples to be described herein provide a method of cleaning an amorphous silicon electrophotographic printing drum. The method may comprise contacting the amorphous silicon of the drum with a base and/or an oxidising agent. The method may then involve rinsing the amorphous silicon with a liquid.

Also described are example systems comprising
(i) an electrophotographic printing apparatus comprising a removable amorphous silicon electrophotographic printing drum; and
(ii) a cleaning station for accepting the amorphous silicon electrophotographic printing drum. The cleaning station may comprise
   (a) a base and/or an oxidising agent for contacting with the drum in the cleaning station; and
   (b) a liquid for rinsing the drum after contacting with the base and/or the oxidising agent.

### Amorphous Silicon Photographic Printing Drum

The amorphous silicon electrophotographic printing drum can be any drum suitable for use in an electrophotographic printing process and which comprises a photoconductive layer comprising amorphous silicon. Amorphous silicon is a non-crystalline allotrope of silicon. In some embodiments, the drum comprises an electrically conductive substrate having a layer of amorphous silicon thereon, which, during printing, may act as an image receiving layer. The electrically conductive substrate may comprise or be a metal, e.g. chrome or aluminium, or electrically conductive compound, e.g. indium tin oxide. In some examples, the electrically conductive substrate may be disposed on an insulating layer. The insulating layer may comprise an electrically insulating material, which may be selected from glass, alumina or quartz.

The drum may be cylindrical, and the amorphous silicon may be disposed on an outer curved surface of the drum that connects two circular ends of the drum.

The amorphous silicon may be disposed on the curved surface along part of, or all of, the length of the drum, the length of the drum being along the axis of the drum. The amorphous silicon may be disposed on the curved surface all or part way circumferentially around the drum.

Before the method of cleaning, the drum may have been used in an electrophotographic printing process and may have contaminants on the surface of the amorphous silicon. The drum may have been subjected to at least 10,000 print cycles. In some examples, the drum may have been subjected to at least 100,000 print cycles, in some examples at least 200,000 print cycles, in some examples at least 300,000 print cycles, in some examples at least 500,000 print cycles, in some examples at least 1,000,000 print cycles. A print cycle in the present context may be defined as the printing on one sheet of of print media, e.g. a sheet of A4 or A3 size.

### Base

In some examples the base is selected from a metal hydroxide, ammonia, an alkyl amine, a metal carbonate, and a metal hydrogen carbonate, and/or the base may be in, e.g. dissolved in, a liquid carrier medium, which may be a protic solvent, including, but not limited to, a protic solvent selected from water and an alkanol, e.g. a C1 to C5 alkanol, e.g methanol and ethanol. In some examples, the base is ammonium hydroxide, which may be considered to be ammonia in water.

The metal hydroxide may be selected from an alkali metal hydroxide, including, but not limited to, lithium hydroxide, sodium hydroxide, potassium hydroxide, and caesium hydroxide, and an alkali earth metal hydroxide, including, but not limited to, magnesium hydroxide, calcium hydroxide and barium hydroxide.

The alkyl amine may be selected from a primary alkyl amine, a secondary alkyl amine and a tertiary alkyl amine. The alkyl amine may be of the formula NR^{a}R^{b}R^{c}, wherein R^{a}, R^{b} and R^{c} are each selected from H and an optionally substituted alkyl, and at least one of R^{a}, R^{b} and R^{c} is an optionally substituted alkyl, which may be straight chain or branched and which may be an optionally substituted C₁ to C₁₀ alkyl (C₁ to C₁₀ not including any substituents that may be present), in some examples an optionally substituted C₁ to C₅ alkyl, in some examples an optionally substituted C₁ to C₃ alkyl. If the alkyl is substituted, the substituents on the alkyl may be selected, for example, from hydroxyl, alkyloxy, aryl, and halogen. The alkyl amine may be selected from methylamine, ethylamine, ethanol amine, dimethylamine, methylethanolamine and trimethylamine.

The metal of the aqueous metal hydroxides may be selected from alkali metal hydroxides, including, but not limited to, lithium hydroxide, sodium hydroxide, potassium hydroxide, and caesium hydroxide.

The metal of the metal carbonates or metal hydrogen carbonates may be an alkali metal, e.g. lithium, sodium or potassium.

### Oxidising Agent

The oxidising agent may be selected from a peroxide, ozone, a peroxyacid, and an oxyacid, which may be a metal oxyacid. The peroxide may be selected from hydrogen peroxide, barium peroxide, benzoyl peroxide, 2-butanone peroxide, tert-butyl hydroperoxide, calcium peroxide, cumene hydroperoxide, dicumyl peroxide, lithium peroxide, benzoyl peroxide, benzoyl peroxide, di-tert-butyl peroxide, di-tert-amyl peroxide, lauroyl peroxide, tert-butyl hydroperoxide, magnesium peroxide, nickel peroxide, sodium peroxide, strontium peroxide and zinc peroxide. The peroxy acid may be selected from perbenzoic acid, 3-chloroperbenzoic acid, peracetic acid. The The oxidising agent may be selected from a chromate, a permanganate and osmium tetroxide. The chromate may be selected from ammonium dichromate, 2,2′-Bipyridinium chlorochromate, bis(tetrabutylammonium) dichromate, chromiurn(VI) oxide, imidazolium dichromate, potassium dichromate, pyridinium dichromate, sodium dichromate dehydrate, and tetrabutylammonium chlorochromate.

In some examples, the base and the oxidising agent are present together in a carrier liquid during contacting with the amorphous silicon. The base and the oxidising agent may be dissolved in the carrier liquid. In some examples, the carrier liquid is or comprises water and/or an alkanol. In some examples, the carrier liquid is or comprises water, which may be deionised water. In some examples, the base and the oxidising agent may be dissolved in the carrier liquid, which may be or comprise water, and, in some examples, the carrier liquid lacks or substantially lacks any particulate components. In some examples, the base and the oxidising agent may be dissolved in the carrier liquid, which may be or comprise water, and the carrier liquid lacks or substantially lacks any other components.

In some examples, the base and the oxidising agent are present together in, e.g. both dissolved in, a carrier liquid, which may be water, during contacting with the amorphous silicon, wherein the wt:wt ratio of base:oxidising agent is 10:1 to 1:10, and in some examples, the wt:wt ratio of base:oxidising agent is 2:1 to 1:2, and in some examples the wt:wt ratio of base:oxidising agent is 1.5:1 to 1:1.5, in some examples about 1:1.

In some examples, the base and the oxidising agent are present together in, e.g. both dissolved in, a carrier liquid, which may be water, during contacting with the amorphous silicon, wherein the base comprises ammonia, and the oxidising agent comprises hydrogen peroxide, and, in some examples, wherein the wt:wt ratio of ammonia:hydrogen peroxide is 10:1 to 1:10, and in some examples, the wt:wt ratio of ammonia:hydrogen peroxide is 2:1 to 1:2, and in some examples the wt:wt ratio of ammonia:hydrogen peroxide is 1.5:1 to 1:1.5, in some examples about 1:1.

In some examples, the carrier liquid containing the base and the oxidising agent is formable by combining 1 part by volume of ammonium hydroxide (e.g. containing about 20-30 wt % ammonia, the balance being water), 1 part by volume of aqueous hydrogen peroxide (e.g. containing about 20 to 35 wt % hydrogen peroxide, with the balance water) and 5 parts by volume water, which may be deionised water.

In some examples, the base and the oxidising agent are at a temperature of at least 40° C. during the contacting with the amorphous silicon of the drum, in some examples at least 50° C. during the contacting with the amorphous silicon of the drum, in some examples at least 60° C. during the contacting with the amorphous silicon of the drum, in some examples at least 70° C. during the contacting with the amorphous silicon of the drum, in some examples a temperature of from 50° C. to 100° C., in some examples a temperature of from 70° C. to 90° C., in some examples a temperature of from 75° C. to 85° C., in some examples a temperature of about 80° C. during the contacting with the amorphous silicon of the drum.

The base and the oxidising agent may contact the amorphous silicon of the drum for a period of at least 1 minute, in some examples at least 5 minutes, in some examples at least 8 minutes, in some examples at least 10 minutes, in some examples a period of from 5 minutes to 20 minutes, in some examples a period of from 10 minutes to 20 minutes, in some examples a period of 12 to 18 minutes, in some examples a period of about 15 minutes.

In some examples, the base and the oxidising agent are at a temperature of from 50° C. to 100° C., in some examples a temperature of from 70° C. to 90° C., in some examples a temperature of from 75° C. to 85° C., in some examples a temperature of about 80° C. during the contacting with the amorphous silicon of the drum, and the base and the oxidising agent may contact the amorphous silicon of the drum for a period of a period of from 5 minutes to 20 minutes, in some examples a period of 10 minutes to 20 minutes, in some examples a period of 12 to 18 minutes, in some examples a period of about 15 minutes.

The contacting of the base and the oxidising agent with the amorphous silicon of the drum may involve immersing at least some, in some examples all, of the drum in a carrier liquid, e.g. water, comprising the base and the oxidising agent. In some examples, the contacting of the base and the oxidising agent with the amorphous silicon of the drum may involve spraying or running a carrier liquid comprising the base and the oxidising agent over at least some, in some examples all, of the surface of the amorphous silicon of the drum.

The method of cleaning need not involve contacting with drum with any particulate matter.

In some examples, the base and oxidising agent remove organic residues and other contaminants from the surface of the amorphous silicon and/or may form a protective silicon dioxide layer (e.g. about 10 Å thick) on the surface of the silica.

### Liquid

The method may involve rinsing the amorphous silicon with a liquid, which may lack or substantially lack an oxidising agent and a base. The liquid used for rinsing may be the same as or different from any liquid that is used as a carrier liquid for the oxidising agent and the base during the contacting step. The method may involve rinsing the amorphous silicon with a liquid immediately after the contacting the drum with the base and the oxidising agent. There may be no intervening steps between (i) the contacting of the amorphous silicon with the base and the oxidising agent and (ii) the rinsing of the drum with a liquid. The liquid may be a liquid in which the base and/or the oxidising agent are soluble. The liquid may be a protic solvent, e.g. a liquid selected from water and an alkanol. The rinse may remove all or substantially all of the base and the oxidising agent from the drum, and any other matter that may have been removed from the surface of drum during the contacting.

After the rinsing, the drum may be dried, e.g. by passing a gas and/or by heating the drum, to remove, e.g. evaporate the liquid from rinsing from the drum. After rinsing, the drum may be used in an electrophotographic printing process.

### System

Examples also provide systems comprising
(i) an electrophotographic printing apparatus comprising a removable amorphous silicon electrophotographic printing drum; and
(ii) a cleaning station for accepting the amorphous silicon electrophotographic printing drum. The cleaning station may comprise
   (a) a base and an oxidising agent for contacting with the drum in the cleaning station; and
   (b) a liquid for rinsing the drum after contacting with the base and the oxidising agent.

The base and the oxidising agent may be retained in the cleaning station separately or together. The cleaning station may be adapted for the separate contact of the base and the oxidising agent with the drum. In some examples, the cleaning station may comprise separate receptacles, each containing one of the base and the oxidising agent, so that the drum can be contacted separately with the base and the oxidising agent. The cleaning station may be adapted to rinse the drum after contact with the base and before the oxidising agent or, in another example, after contact with the oxidising agent and before the base. In some examples, the cleaning station is adapted to contact the base and the oxidising agent at the same time with the drum. The cleaning station may comprise a receptacle containing the base and the oxidising agent, which may be in a carrier liquid, so that the drum can be contacted with, e.g. immersed in, the base and the oxidising agent, or, if present, the carrier liquid containing the base and the oxidising agent. The cleaning station may retain the base and the drum in any suitable receptacle, which may have walls of a material that is resistant to corrosion from the base and the oxidising agent. The receptacle may, for example, have walls comprising a material selected from a glass, a metal, such as stainless steel, or a plastic, such as polyethylene.

In some examples the system is adapted to automatically (i) transfer the amorphous silicon electrophotographic printing drum from the electrophotographic printing apparatus to the cleaning station, (ii) carry out a method of cleaning the drum involving contacting the amorphous silicon of the drum with a base and an oxidising agent; and then rinsing the amorphous silicon with a liquid, and (iii) transfer the amorphous silicon electrophotographic printing drum from the cleaning station back to the electrophotographic printing apparatus. The system may be adapted to transfer the amorphous silicon electrophotographic printing drum from the electrophotographic printing apparatus to the cleaning station at a point that is predetermined, e.g. when a certain level of background is measured on print media during printing or when a certain number of print cycles have been reached, e.g at least 200,000 print cycles, in some examples at least 300,000 print cycles, in some examples at least 500,000 print cycles, in some examples at least 1,000,000 print cycles, or at a point initiated by a user. The system may be adapted to carry out a method as described herein, either manually or automatically. The system, in operation, may be controlled by a computer.

### EXAMPLES

The following illustrates examples of the methods and other aspects described herein. Thus, these described examples should not be considered as limitations of the present disclosure, but are merely in place to teach how to make examples of the present disclosure.

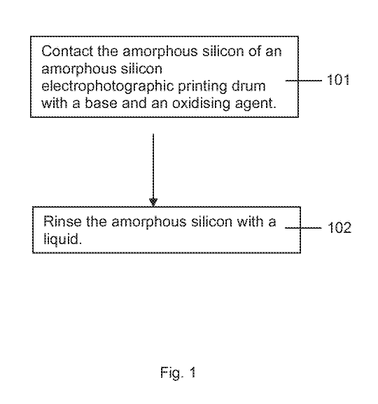

FIG. 1 illustrates schematically an example of the method described herein. In step 101, the amorphous silicon of amorphous silicon electrophotographic printing drum is contacted with a base and an oxidizing agent. In step 102, the amorphous silicon is rinsed with a liquid.

### Comparative Example 1

An amorphous silicon electrophotographic printing drum was aged in an electrophotography process (charging, discharging and ink development) for a period of 7 million cycles. The print quality of printed pages had degraded to unacceptable quality.

### Example 2

A strip of one third of the morphous silicon in the amorphous silicon drum of Comparative Example 1 was immersed in solution of 5 parts by volume of deionised water, 1 part by volume of aqueous NH₄OH (the 1 part of aqueous NH₄OH containing about 29 wt % NH₃, with the balance water), and 1 part by volume of aqueous H₂O₂ (the 1 part aqueous H₂O₂ containing 30 wt % H₂O₂, with the balance water), for 15 minutes at 80° C.

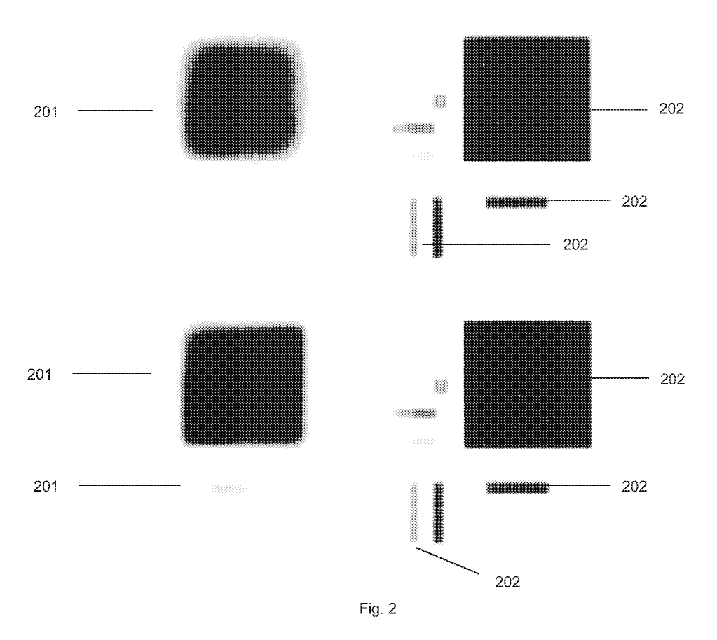

The drum was rinsed with pure water and wiped with lint-free wipes. The drum was installed on a HP Indigo 5000 electrophotographic printer in order to print a test job of squares, dots and lines. FIG. 2 shows a print media printed with the part-cleaned silicon drum. The right hand side represents the parts of the print media that was printed with the third of the drum that had been contacted with the aqueous solution of NH₄OH and H₂O₂. The left hand side represents the parts of the print media that was printed with the untreated part of the drum. The print patterns sent to each side of the drum were reflections of one another along the centre of the page (i.e. along the line from top to bottom of figure when viewed in portrait). As can be seen in FIG. 1, the print resulting from the treated area (right-hand side) looks much sharper than the untreated area (left-hand side): the blurriness disappeared and lines and dots patterns were restored. It has been found that a base-peroxide mixture removes organic residues and is also very effective in removing particles from the surface. This is believed to result, at least in part, in the improved print quality.

In electrophotographic printing, over time, it has been found that the surface of amorphous silicon drums form an outer, contaminated layer which reduces the drum's print quality due to lateral conductivity within the surface. It has been discovered that, if the surface is cleaned by contacting it with a base and an oxidising agent (which removes the oxide layer and other contaminants), then only a very thin layer of the amorphous silicon is removed and so photoconductive width is not substantially reduced. This is an advantage over abrasion techniques, which may involve, for example, contacting inorganic particulates during cleaning with the surface of the silicon, which can lead to a much greater reduction in photoconductive depth and can shorten the lifespan of the drum.

While the method and related aspects have been described with reference to certain examples, those skilled in the art will appreciate that various modifications, changes, omissions, and substitutions can be made without departing from the spirit of the disclosure. It is intended, therefore, that the method and related aspects be limited by the scope of the following claims. The features of any dependent claim can be combined with the features of any of the other dependent claims, and any independent claim.

1. A method of cleaning an amorphous silicon electrophotographic printing drum, the method comprising:
a. contacting the amorphous silicon of the drum with a base and an oxidising agent; and then
b. rinsing the amorphous silicon with a liquid.

2. A method according to claim 1, wherein the base is selected from metal hydroxides, ammonia, an alkyl amine, metal carbonates, and metal hydrogen carbonates.

3. A method according to claim 1, wherein the base comprises a species selected from ammonia and an alkyl amine.

4. A method according to claim 1, wherein the oxidising agent is selected from a peroxide, ozone, a peroxyacid, and an oxyacid.

5. A method according to claim 1, wherein the base comprises a species selected from ammonia and an alkyl amine and the oxidising agent is selected from a peroxide, ozone, a peroxyacid, and an oxyacid.

6. A method according to claim 1, wherein the base comprises ammonia, and the the oxidising agent comprises hydrogen peroxide.

7. A method according to claim 6, wherein the base and the oxidising agent are present together in a carrier liquid during contacting with the amorphous silicon.

8. A method according to claim 7, wherein the carrier liquid is water and the base and the oxidising agent are dissolved in the water.

9. A method according to claim 1, wherein the base and the oxidising agent are present together in a carrier liquid during contacting with the amorphous silicon, wherein the base comprises ammonia, and the oxidising agent comprises hydrogen peroxide, wherein the wt:wt ratio of ammonia:hydrogen peroxide is 10:1 to 1:10.

10. A method according to claim 9, the wt:wt ratio of ammonia:hydrogen peroxide is 2:1 to 1:2.

11. A method according to claim 9, wherein the wt:wt ratio of ammonia:hydrogen peroxide is 1.5:1 to 1:1.5.

12. A method according to claim 1, wherein the base and the oxidising agent are at a temperature of at least 70° C. during the contacting with the amorphous silicon of the drum.

13. A method according to claim 1, wherein the liquid used in rinsing the amorphous silicon is or comprises water.

14. A system comprising
(i) an electrophotographic printing apparatus comprising a removable amorphous silicon electrophotographic printing drum; and
(ii) a cleaning station for accepting the amorphous silicon electrophotographic printing drum, the cleaning station comprising
(c) a base and an oxidising agent for contacting with the drum in the cleaning station; and
(d) a liquid for rinsing the drum after contacting with the base and the oxidising agent.

15. The system according to claim 14, wherein the system is adapted to automatically (i) transfer the amorphous silicon electrophotographic printing drum from the electrophotographic printing apparatus to the cleaning station, (ii) carry out a method of cleaning the drum involving contacting the amorphous silicon of the drum with a base and an oxidising agent; and then rinsing the amorphous silicon with a liquid, and (iii) transfer the amorphous silicon electrophotographic printing drum from the cleaning station back to the electrophotographic printing apparatus.
